(19) United States
(12) Patent Application Publication
(10) Pub. No.: US 2010/0021582 A1
(43) Pub. Date: Jan. 28, 2010

(54) Fermented bubble drink with functionality

(76) Inventor: Tae-Gook Kwon, Seoul (KR)

Correspondence Address: THE NATH LAW GROUP, 112 South West Street, Alexandria, VA, 22314, US

(21) Appl. No.: 12/457,179

(22) Filed: Jun. 3, 2009

Related U.S. Application Data
(63) Continuation of application No. 12/205,071, filed on Sep. 5, 2008, now abandoned.
Application No. 12/205,071 is a continuation of application No. PCT/KR2007/001118, filed on Mar. 6, 2007.

(30) Foreign Application Priority Data
Aug. 7, 2001 (KR) 10-2006-0020784

(51) Int. Cl. A23L 2/00; C12G 1/00; A23C 9/154; C12C 11/00; A23C 9/12; A23L 1/214

(52) U.S. Cl. 426/11; 426/442; 426/61; 426/18; 426/569

(57) ABSTRACT

The present invention relates to a bubbled foamy drink which is provided by applying a bubbling engineering process to various functional foods, particularly, fermented foods supplied using various fermentation techniques, that have functions to control the activation of bioregulatory functions in view of biological defense and physical rhythm control and preventive medicine in lives, including humans.

The bubble drink is produced by applying a cold bubbling process to bioavailable food materials, based on bubbling engineering technology, to design and manipulate formation reactions of foam in a creative and easy manner. The bubble drink is suitable for drinking, and is characterized in that a foamy structure can be easily obtained at ambient pressure and temperature, a flow of materials can be intentionally manipulated, which is an inherent characteristic of foam, and unit processes can be varied during in-line automatic production, which is a characteristic of modern industry, without involving considerable additional expense.

### BACKGROUND OF THE INVENTION

1. Field of the Invention

The present invention relates to a bubbled foamy drink provided by applying a bubbling engineering process to various functional foods, particularly, fermented foods supplied using various fermentation techniques, that have functions to control the activation of bioregulatory functions in view of biological defense and physical rhythm control and preventive medicine in lives, including humans.

2. Description of the Background

In connection with the present invention, the concept of bubbling engineering technology is already known in Patent Application PCT KR 2007-001040 filed by the present applicant. Bubbling processes can be classified into hot bubbling processes and cold bubbling processes. In hot bubbling processes, a rapid temperature rise occurs by heating to induce a phase change. In cold bubbling processes, surface activation is achieved by using a catalyst or inducing turbulence in an overcooled state, resulting in phase separation.

The bubbling engineering technology is defined as a process wherein additives for various purposes and applications are added to bioavailable food materials selected from grain powders, natural protein foods, etc. to prepare a colloidal solution, and thereafter, the colloidal solution is reacted with a gas-containing aqueous solution to prepare a foamy colloid. The bubbling engineering technology can be realized by a combination of techniques based on the following basic mechanisms:
1. Powder processing and mixing techniques of the bioavailable food materials enable manufacturers to program the reaction procedures and the application purposes on the materials;
2. The reaction speed can be controlled by varying the crystal state of the saccharides, so that the reaction rates of the respective steps can be controlled;
3. The number, size and mobility of air bubbles can be manipulated by controlling the amount of protein;
4. Manipulating the state (e.g., kind, pressure (including partial pressure), temperature and state) of the gas can remotely control the environments of biochemical reactions in a living body (e.g., partial pressure control control of biochemical reactions control of pharmacological effects for health and hygiene improvement); and
5. The stabilizing procedure of the bubble colloid, which is slowly separated into an aggregation of foam scum and a body of brewed solution and stabilized with the passage of time, can be controlled and utilized for fermentation.

The final product produced by bubbling engineering process in the present invention may be a 3-state complex (the composite state of gas, liquid and solid) bubble structure, an aggregation of foam scum, a body of brewed solution (patterned water), a stabilizing process, or a combination thereof. Bubble drink products by this invention can be served by impromptu (improvised) cuisine of simply mixing two major functional materials, i.e. a gas-saturated drink and a food concentrate in colloidal dispersion state, and hence spontaneously forming a fluent complex aggregation of gas bubbles, and then are ingested by means of drinking in the form of synthetic construction as named ‘bubble drink’ which enables ingesta not only to help the living subject to keep and/or improve health but also to attain various functional effects when carefully designed and controlled. Those beneficial results are achieved by the property of bubble drink maximizing the introduction of gas within the digestive system with a soft feeling of gulp, thereby increasing the functional efficiency of the ingested gas materials.

From the viewpoint of the size criteria of dispersed particles, a colloidal solution constituting bubble drink can be defined as ‘complex colloid’ in which the three types coexist. By the definition of colloid, accordingly, the physicochemical properties of bubble drink are dependent on the sizes of the constituent materials and irrespective of those properties and thereby, the term ‘complex colloid’ naturally secures a wide variety of choice in identifying bubble drink material constituents, thus excluding the need for additional longwinded explanation thereof.

The design of bubble drink was invented considering the common pattern of ingestion of all kinds of food and drink, and, so long as the basic requirements described herein are met, any food or drink undergoing a change in composition can be ingested in the form of bubble drink as an instant food which is produced by converting ingesta into a blast of bubbled structure in 3 state complexity of solid, liquid and gas even under the various influences of the actual life environment. An invention involving phase changes and exhibiting potent thermodynamic and quantum mechanical properties as stated in the present invention will never produce products having completely identical fingerprints. Furthermore, food ingestion environmental conditions cannot be manipulated just like those in laboratories and so potential instability and change cannot be avoidable. Under such environmental systems, an invention associated with a method for ingesting a physicochemically stable food or drink must ensure a consistency in the practice of the invention even under various and comprehensive daily life environments. With reference to technical and experimental data associated with the basic principles of the present invention and embodiments of the present invention, the technical spirits will be described below from the standpoint of the features and purposes of the present invention.

According to a generally known method for producing a functional fermented food, after water is mixed with materials to be processed in an optimal ratio, the mixture is fermented and aged under constant temperature conditions.

The present invention relates to a follow-up technique of bubble drink disclosed in Patent Application PCT/KR2007/001040 entitled “Bubble Drink Provided by Bubbling Engineering Process” which was filed by the present applicant, and the technical spirit of the present invention is associated with a functional fermented bubble drink provided by adding a fermented food to the bubble drink disclosed in the patent application to impart additional characteristic functions to the bubble drink.

For example, a powder of soup prepared with fermented soybeans may be added during production of the final bubble drink.

Particularly, experimental results obtained from the production of cheese whey from milk by fermentation indicate that the production of milk-rich bubble drinks by fermentation can open a new market in the application of new flavored foods and drinks by alcoholic fermentation and lactic acid bacteria fermentation (as shown in “Alcoholic fermentation of cheese whey by mixed culture of Kluyveromyces marxianus and lactic acid bacteria” Sim Young Sup, Kim Jae Won and Yoon Seong Sik, Korean J. Food SCI. Technol. Vol. 30, No. 1, pp. 161˜167 (1998)).

### SUMMARY OF THE INVENTION

The present inventor has earnestly and intensively conducted research to develop a process by which a cold bubbling process is applied to bioavailable food materials, based on bubbling engineering technology, to design and manipulate formation reactions of foam in a creative and easy manner. As a result, the present inventor has succeeded in developing a bubble drink suitable for drinking, characterized in that a foamy structure can be easily obtained at ambient pressure and temperature, a flow of materials can be intentionally manipulated, which is an inherent characteristic of foam, and unit processes can be varied during in-line automatic production, which is a characteristic of modern industry, without involving considerable additional expense.

It is one object of the present invention to provide a functional fermented bubble drink that is produced by applying bubbling engineering process to various fermented foods while keeping reserving the effective ingredients obtained from fermentation and aging, and that is programmed such that the physical rhythm of lives be optimized and the effect of caloric intake by consumers be rightly controlled.

It is another object of the present invention to provide a functional fermented bubble drink that is produced by converting fermented foods to a form of bubbles having a three-state composite structure of gas, liquid and solid so as to be ingested and functioning within the digestive system. That is, the above objects of the present invention are accomplished by a programmed bubble drink that is to be produced with designing various functional components to include fermented nutrition determined to be necessary to maintain or improve the health of organism in view of the characteristics of individuals.

### DETAILED DESCRIPTION OF THE PREFERRED EMBODIMENTS

Thus, the present invention provides a method for producing a functional fermented bubble drink using bubbling engineering process to effectively provide functional materials to a consumer. Specifically, the method of the present invention entails the steps of:

steaming and drying or slightly parching natural grains, pulverizing the dried or parched natural grains to prepare a fine powder of roasted grains, adding functional ingredients and fermented food ingredients to the fine powder of roasted grains while maintaining the humidity of the fine powder below 5%, and pulverizing the mixture to prepare a powder having a size of 10 μm or less (first step); pulverizing a crystalline powder or granular crystal of a monosaccharide or oligosaccharide to prepare a crystalloid powder having a size of 10 μm or less (second step), and controlling the composition and characteristics of the saccharide necessary for glycosylation (in the case of patients suffering from diabetes, a harmful ingredient, such as sugar or glucose, may be excluded) (second step);

preparing a powder or an extract of functional raw materials selected from strains, inocula, and/or powders, extracts, powdery pills and concentrates of ginseng steamed red, etc, to impart particular additional functions such as fermentation to a final bubble drink product (third step);

mixing the raw materials prepared in the first, second and third steps, controlling the particle size of the mixture, adding a functional material (e.g., honey) to the powder, and mixing the mixture with a colloidal solution (e.g., milk) in the form of a protein emulsion-suspension to prepare a food concentrate in a gel state (fourth step);

pulverizing, rotating or swirling the food concentrate while adding a liquid (e.g., milk) to the food concentrate to convert the gel into a sol, and freely dropping a gas-saturated solution on the sol to generate a bubble blast (bubbling engineering process) (fifth step); and

storing the bubble drink consisting of separates of liquid and foam phases in one container, or separating the two phases and storing in different containers (sixth step).

In the third step above-stated, the functional raw materials may be in the form of a powder of pulverizing the lyophilized food or an extract prepared by lyophilizing a fermented food.

In the fourth step, a functional material may be further added during mixing of the raw materials prepared in the previous steps. The functional material is selected taking into consideration the purpose of drinking, functions, and demand and taste of a consumer. Preferably, CO₂ is added in the form of a dry ice powder during the mixing.

The bubble drink consisting of separates of liquid and foam phases prepared in the fifth step is tightly sealed, followed by alcoholic fermentation or lactic acid bacteria fermentation. In the fifth step, vegetable soup is further added during conversion of the gel into a sol. The vegetable soup may be prepared by gently heating one-half of a carrot, one-fourth of a radish, one-fourth of dried radish leaves, one-fourth of a burdock and one dried oak mushroom in two liters of water for one hour, followed by cooling.

The present invention also provides a bubble drink that is ingested such that the amount of intake of a consumer is satisfied, offering a sense of satiety to the consumer wherein the bubble drink is produced by a method comprising the steps of:

steaming and drying or slightly parching natural grains, and pulverizing the dried or parched natural grains to prepare a fine powder of roasted grains, and adjusting the amount of the fine powder of roasted grains to the caloric intake of a consumer while maintaining the humidity of the fine powder below 5% (first step);

pulverizing a crystalline powder or granular crystal of a monosaccharide or oligosaccharide selected from solid substances including sugar, lactose, starch sugar, oligosaccharide, dextrin, α-starch and D-mannitol to prepare a saccharine crystalloid powder having a size of 10 μm or less (second step);

lyophilizing a fermented food and pulverizing the lyophilized food to prepare a powder of the lyophilized food or pulverizing a functional raw material for imparting particular functions to a final bubble drink to prepare a powder of the functional raw material (third step);

adsorbing and distributing the powders prepared in the previous steps in a wind tunnel to obtain a powder having a particle size of 10 μm or less, adding a functional material to the powder, and mixing the mixture with a colloidal solution, such as milk, in the form of a protein emulsion to prepare a food concentrate in a gel state (fourth step); and

pulverizing, rotating or swirling the food concentrate to convert the gel into a sol, and freely dropping a gas-saturated solution on the sol to generate a bubble blast (bubbling engineering process) (fifth step).

In the fifth step, it is preferred to further add vegetable soup to control the nutritive conditions of the bubble drink.

The above objects of the present invention can be accomplished in various forms, for example, by the provision of a bubble drink for dietary treatment of a disease, such as obesity or diabetes, that is ingested such that the caloric intake of a consumer suffering from the disease is controlled while offering a sense of satiety to the consumer wherein the bubble drink is produced by a method comprising the steps of:

steaming and drying or slightly parching natural grains, and pulverizing the dried or parched natural grains to prepare a fine powder of roasted grains, and adjusting the amount of the fine powder of roasted grains to the caloric intake of a consumer while maintaining the humidity of the fine powder below 5% (first step);

pulverizing a crystalline powder or granular crystal of a monosaccharide or oligosaccharide selected from solid substances including sugar, lactose, starch sugar, oligosaccharide, dextrin, α-starch and D-mannitol to prepare a saccharine crystalloid powder having a size of 10 μm or less (second step);

processing a functional raw material for imparting particular functions to a final bubble drink into a powder or extract (third step);

mixing the raw materials prepared in the previous steps by adsorption and distribution in a wind tunnel to obtain a powder having a particle size of 10 μm or less, adding a functional material to the powder, and mixing the mixture with a colloidal solution, such as milk, in the form of a protein emulsion to prepare a food concentrate in a gel state (fourth step); and

pulverizing, rotating or swirling the food concentrate to convert the gel into a sol, and freely dropping a gas-saturated solution on the sol to generate bubble blast (a bubbling engineering process) (fifth step).

The functional material used in the third step may be ginseng extract A or B. The functional material may be a cacao extract containing dietary fibers. The functional material may be a soybean fermented food produced using Rhizopus nigricans disclosed in Korean Patent No. 681532, a lyophilized product of Opuntia ficus-indica var., saboten or soup prepared with fermented soybeans, or the like. It is apparent to those skilled in the art of foods that the technical spirit of the present invention can be applied to all general fermented foods. By adding at least one suitable material during the preparation of the designed colloidal solution and violently mixing with the aqueous solution, the taste, fragrance and functions of the final drink are controlled and enhanced in a very easy manner.

That is, the control of the foam-forming catalyst is more effective and simpler than that of the gas carrier. Particularly, foam functions to preserve a fragrance, e.g., xylitol, for a prolonged time and to emit an aroma through the oral cavity for a long time after ingestion. Therefore, it is believed that the bubble drink is most effective in producing aromatic diet drinks.

Further, various tastes of people can be reflected according to the kind of a material added to colloidal particles as dispersion media and the reserve vessel material as a dispersoid in the form of an aqueous solution. Furthermore, it is very easy to mix the drink with at least one hygienic and pharmacologically active substance selected from aromatic ingredients, healthy food ingredients and therapeutic ingredients (e.g., cold medicines, drugs for promoting blood circulation, internal medicines for treating hypertension, internal medicines for treating tinea pedis, etc) and to take the mixture.

As apparent from the above description, the functional fermented bubble drink of the present invention is produced by applying bubbling engineering process to various fermented foods while keeping effective ingredients obtained from fermentation and aging and is programmed such that the physical rhythm of an organism can be optimized and the amount of caloric intake of consumers can be justly consumed in view of preventive medicine.

Since the functional and fermented bubble drink of the present invention comprises a fermented food and pharmacologically active functional ingredients, which control biological functions and rhythm, prevent various diseases such as diabetes, control diseases to assist in the recovery of the patients, enhance immunocompetence, etc.

According to the functional fermented bubble drink of the present invention, pharmacologically active substances, such as ribonucleic acids, oligosaccharides, chitosan, polysaccharides, amino acids and oligopeptides, are provided as various additives. As a result, the functional fermented bubble drink of the present invention serves primary nutritive functions of food, bioregulatory functions, and preventive, curative and protective functions against various diseases.

In addition, the bubble drink of the present invention provides improved physical constitution of the weak, the elderly, children and patients under medical treatment by programming or designing the composition of the bubble drink depending on various intended purposes, including biological defense, physical rhythm control, prevention of diseases, recovery from diseases and enhancement of natural immune function.

The following examples are provided to compare the degree of separation between foamy and liquid phases of a complex bubble-net structure of three states, i.e. solid, liquid and gas states (or a bubble network <3 state bubble-net solution>, referred to simply as a ‘slg complex bubble-net structure’ or a ‘slg-CBS’ with the passage of time according to the composition of the materials.

The following examples are given to make the practice of the present invention easier. In the following examples, commercially available products, i.e. a CO₂-containing aqueous solution, milk, sugar, and a fine powder of roasted grains (hereinafter, referred to as a ‘fiporog’ were used as four basic ingredients. It was found through experiments that although various additives having different materials and compositions thereof were used for various purposes to produce bubble drinks, the bubble drinks showed similar effects without significant differences in terms of their physical properties.

This finding proves that the bubble drink of the present invention has stable and consistent physical properties, irrespective of the nature and mixing of the materials used. The following examples are not intended to limit the intrinsic principle and constitution of the present invention as disclosed in the accompanying claims.

In a simpler method, a flavored carbonated drink was mainly used as a gas carrier. The flavored carbonated drink can be prepared by any well-known method. Mineral water (CO₂ content: 1.112%) produced from Chojeong-ri, Chungcheongbuk-do, Korea, natural soda pop, and flavored carbonated drink products, including Coca-Cola Zero, Kin Cider, Fanta and Demisoda, were used in the following examples. All drink products were stored in a freezer at 5° C. The volume of each of the carbonated drinks was measured in a cylindrical container having a diameter of 9 cm and a height of 9 cm at ambient pressure and room temperature. The height of each of the carbonated drinks was measured in a glass having a height of 12 cm and a diameter of 6 cm, which is routinely used at home. A colloidal solution (milk+powder of roasted grains+sugar) was added to the glass, and a gas carrier fell freely from a height of 30 cm within 5 seconds to induce turbulence. As a result, a bubble colloid was obtained. The maximum volume of the bubble colloid was expressed in Vₘₐₓ. The milk can be prepared by an ordinary technique. In the following examples, E⁺ Supgol Milk (provided by FamilyMart Co., Korea), Pasteur Fresh Milk (produced by Pasteur Milk Co., Korea) and Pasteur Organic Milk (produced by Pasteur Milk Co., Korea) were used. A mixture of a concentrate of ginseng steamed red, yogurt, vinegar, an alcoholic beverage, honey, fresh egg, mayonnaise, butter, soybean soup and sesame oil, all of which are in a colloidal state, as edible additives was used. The addition of butter and sesame oil caused a reduction in foaming function. A parched cereal powder, a parched food powder and a powder of vegetable enzymes were readily prepared by well-known techniques. In the following examples, three powders of different types were used.

Fine powder of roasted grains A (fiporog A): Unhulled barley (37.5%), brown rice (25%), brown glutinous rice (18.7%), black soybean (16.3%), and others (chestnut, sea tangle, etc)

Fine powder of roasted grains B (fiporog B): Barley (27%), brown rice (25%), corn (25%), brown glutinous rice (10%), black soybean (10%), and others (potato, sweet potato, sea tangle, etc) Fine powder of roasted grains C (fiporog C): A fine powder of roasted grains for parched food, which was prepared by processing a mixture of a parched cereal powder and dry parcned food materials wherein the parched cereal powder consists of brown glutinous rice (13%), barley (13%), unhulled barley (15%), brown rice (13%), black soybean (13%), white soybean (4.4%), unshelled grains of adlay (4.4%), African millet (4.4%) and corn (4.4%) and wherein the dry parched food materials consist of sesame (2.2%), black sesame (2.2%), wild sesame (2.2%), sweet potato (0.88%), potato (0.88%), sea tangle (0.44%), anchovy (0.44%), brown seaweed (0.44%), chestnut (0.88%), mushroom (0.44%), spinach (0.44%), cabbage (0.44%), mugwort (0.44%), onion (0.44%), banana (0.44%), an embryo bud of brown rice (0.88%), pumpkin (0.44%), carrot (0.44%) and apple (0.44%).

For better taste, nutrition and function, edible additives were mixed, for example, starch flour, york flour, parched wild sesame flour, coffee extract powder, salt powder, green tea flour, powder of ginseng steamed red, concentrate of ginseng steamed red, extract of ginseng steamed red, pepper flour, powder of soup prepared with fermented soybeans, dry ice powder, powder of various vegetable enzymes, powder of herbs and pollen.

As the sugar, white sugar having a diameter of 1 mm or less was mainly used. The sugar was mixed with the parched cereal powder, and then the mixture was pulverized into a fine powder (fiporog A100) having a size of 100 μm or less and a fine powder (fiporog A10) having a size of 10 μm or less.

Although mannitol or xylitol was further added or used instead of the sugar, similar results were obtained.

To measure the degree of separation of the structures, the ratios of a solution state to a foamy state separated from a 100% foamy state with time (0.5 min., 1 min., 5 min., and 10 min.) were expressed as R_{0.5}, R₁, R₅ and R₁₀, respectively. One method selected from the volume and height measurement methods was employed to measure the degree of separation.

Specifically, the ratios were expressed as values of Vₜ(total):Vₗ(liquid):V_{b}(bubble) in ml or values of Hₜ(total):Hₗ(liquid):H_{b}(bubble) in cm. In particular examples (Fanta/cake production and purification functions of contaminants), the turbidity of the separated solution state with the passage of time was measured, relative to the degree of clearness of background letters. The results were evaluated based on three criteria, i.e. Good, Fair and Poor. The present invention will now be illustrated by several Examples which are provided solely for purposes of illustration and are not intended to be limitative.

### Examples

### Example 1

10 g of fiporog A-10 was homogeneously mixed with 10 g of sugar to obtain a powder. The powder was added to 50 ml of Pasteur Fresh Milk (produced by Pasteur Milk Co., Korea) to prepare a composite colloidal solution. When 100 ml of a gas-containing aqueous solution (Fanta) fell freely down the composite colloidal solution, the following measurement results were obtained: Vₘₐₓ=340 ml, Hₘₐₓ=13 cm, R_{0.5}(V)=13:4.3:8.9, R₁(V)=12.3:4.8:7.5, R₅(V)=9.7:3.8:5.9, R₁₀(V)=8.5:4.2:4.3. About 30 minutes after the free fall, a solid structure in the form of a foam crust was obtained.

### Example 2

10 g of fiporog A-10, 10 g of sugar and 1 g of a coffee concentrate powder were homogeneously mixed together to obtain a powder. The powder was added to 50 ml of Pasteur Fresh Milk (produced by Pasteur Milk Co., Korea) to prepare a composite colloidal solution. When 100 ml of a gas-containing aqueous solution (Fanta) fell freely down the composite colloidal solution, the following measurement results were obtained: Vₘₐₓ=340 ml, Hₘₐₓ=13 cm, R_{0.5}(V)=13:3.4:9.6, R₁(V)=11.8:3.8:8, R₅(V)=10.1:3.8:6.3, R₁₀(V)=8.9:4.4:4.5. About 30 minutes after the free fall, a solid structure in the form of a foam crust was obtained.

### Example 3

10 g of fiporog A-10, 10 g of sugar and 10 g of a powder of vegetable enzymes were homogeneously mixed together to obtain a powder. 50 ml of Pasteur Fresh Milk (produced by Pasteur Milk Co., Korea) was added to the powder to prepare a composite colloidal solution. When 100 ml of a gas-containing aqueous solution (natural soda pop) fell freely down the composite colloidal solution, the following measurement results were obtained: Vₘₐₓ=340 ml, Hₘₐₓ=13 cm, R_{0.5}(H)=13:3.5:9.5, R₁(H)=11.9:4.2:7.7, R₅(H)=9.9:3.8:6.1, R₁₀(H)=8.7:4.4:4.3. About 30 minutes after the free fall, a solid structure in the form of a foam crust was obtained.

### Example 4

5 g of fiporog C-10, 5 g of sugar and 5 g of a powder of soup prepared with fermented soybeans were homogeneously mixed together to obtain a powder. The powder was added to 45 ml of Pasteur Organic Milk (produced by Pasteur Milk Co., Korea) to prepare a composite colloidal solution. When 130 ml of a gas-containing aqueous solution (natural soda pop) fell freely down the composite colloidal solution, the following measurement results were obtained: Vₘₐₓ=340 ml, Hₘₐₓ=13 cm, R_{0.5}(H)=12.4:3.5:8.9, R₁(H)=12:5:7, R₂(H)=11.2:6.3:4.9, R₃(H)=10.3:6.8:3.5, R₄(H)=9.5:7.2:2.3, R₅(H)=8.9:7.3:1.6.

### Example 5

5 g of fiporog C-10, 5 g of sugar and 2 g of a powder of ginseng steamed red extract were homogeneously mixed together to obtain a powder. The powder was added to 50 ml of Pasteur Organic Milk (produced by Pasteur Milk Co., Korea) to prepare a composite colloidal solution. The composite colloidal solution was mixed with 10 g of Manuka honey (active 5). When 100 ml of a gas-containing aqueous solution (Mineral water produced from Chojeong-ri, Chungcheongbuk-do, Korea) fell freely down the mixture, the following measurement results were obtained: Vₘₐₓ=340 ml, Hₘₐₓ=13 cm, R_{0.5}(H)=11.6:6.6:5, R₁(H)=10:7:3, R₂(H)=8.7:7.8:0.9.

### Example 6

5 g of fiporog C-10 was homogeneously mixed with 2 g of a powder of ginseng steamed red extract to obtain a powder. The powder was mixed with 15 g of Manuka honey (active 5) to prepare a gel. 50 ml of Pasteur Organic Milk (produced by Pasteur Milk Co., Korea) was added to the gel to prepare a composite colloidal solution in the form of a sol. When 100 ml of a gas-containing aqueous solution (Mineral water produced from Chojeong-ri, Chungcheongbuk-do, Korea) fell freely down the composite colloidal solution, the following measurement results were obtained: Vₘₐₓ=340 ml, Hₘₐₓ=13 cm, R_{0.5}(H)=12:5.5:6.5, R₁(H)=10.5:6.5:4, R₂(H)=8.5:7:1.5.

### Example 7

5 g of fiporog A-100, 5 g of sugar, 5 g of a powder of vegetable enzymes and 1 g of a powder of soup prepared with fermented soybeans were homogeneously mixed together to obtain a powder. 40 ml of Pasteur Fresh Milk (produced by Pasteur Milk Co., Korea) was added to the powder to prepare a composite colloidal solution. The composite colloidal solution was mixed with 20 ml of plain yogurt with stirring. When 100 ml of a gas-containing aqueous solution (natural soda pop) fell freely down the mixture, the following measurement results were obtained: Vₘₐₓ=340 ml, Hₘₐₓ=13 cm, R_{0.5}(H)=13:6.2:6.8, R₁(H)=12.5:7:5.5, R₂(H)=12:4.8:7.2. About 30 minutes after the free fall, a solid structure in the form of a foam crust was obtained.

### Example 8

5 g of fiporog B-10 was homogeneously mixed with 5 g of sugar to obtain a powder. The powder was added to 20 ml of Pasteur Organic Milk (produced by Pasteur Milk Co., Korea) to prepare a composite colloidal solution. The composite colloidal solution was mixed with 10 g of brewing vinegar (acidity: 6-7) of grains with stirring. When 100 ml of a gas-containing aqueous solution (natural soda pop) fell freely down the mixture, the following measurement results were obtained: Vₘₐₓ=340 ml, Hₘₐₓ=14 cm, R_{0.5}(H)=14:6:8, R₂(H)=14:6:8. Immediately after the free fall, a foamy structure was obtained. The foamy structure was an aggregate of big bubbles having a diameter of 1 to 2 cm. The foamy structure was maintained for 5 minutes or more.

### Example 9

5 g of fiporog B-10 was homogeneously mixed with 5 g of sugar to obtain a powder. The powder was added to 20 ml of Pasteur Organic Milk (produced by Pasteur Milk Co., Korea) to prepare a composite colloidal solution. Separately, one-half of a carrot, one-fourth of a radish, one-fourth of dried radish leaves, one-fourth of a burdock and one dried oak mushroom were gently heated in two liters of water for one hour, and then the mixture was cooled to prepare vegetable soup. The composite colloidal solution was mixed with 20 g of the vegetable soup with stirring. When 100 ml of a gas-containing aqueous solution (natural soda pop) fell freely down the mixture, the following measurement results were obtained: Vₘₐₓ=340 ml, Hₘₐₓ=13 cm, R_{0.5}(H)=13:5:8, R₁(H)=13:5.4:7.6, R₂(H)=13:5.7:7.3, R₃(H)=13:5.9:7.1, R₄(H)=12.5:5.9:6.6, R₁(H)=12:5.9:6.1. Six hours after the free fall, the degree of clearness of the solution state was evaluated to be ‘Fair’ Fifteen hours after the free fall, the degree of clearness of the solution state was evaluated to be ‘Good’

The following is a brief explanation of basic concepts involved in implementing basic steps of bubbling engineering to impart functions to the bubble drink.

A crystal powder of white sugar and a grain powder are mixed together and pulverized under pressure to increase the surface energy of the mixture. Thereafter, the fine powder is friction-processed by a turbulent flow. At this time, it is necessary to process the fine powder into a solid aerosol by electrostatic adsorption. This processing can be done in a dry hot-wind tunnel at high temperature (Adsorption; Agent+Dispersant adsorption, wind tunnel; formation of polarized and air-cushioned powder), where gelatinization, drying and fractionation are effected.

When rotational stirring is carried out on a colloid reserve vessel, such as milk, to react the solid aerosol with the colloidal aqueous solution, the adsorption potential between the solid aerosol and the colloidal aqueous solution can be preserved. The rotational stirring is achieved by semi-automatic stirring using the phenomena of permeation, dispersion and diffusion. It was found that the roles of the colloid could be programmed on the materials in the final bubbling step through a combination of the preparation mode and sequence of the colloid.

Then, a sol colloid is prepared. The sol colloid is required to prepare a food concentrate as a bubbling agent. The sol colloid is foamed to prepare a foam colloid. When the foam colloid is in contact with a food concentrate in the form of a colloidal dispersion, a gas-containing aqueous solution absorbs a surface active catalyst by the adsorptive force of a fine powder of roasted grains. As a result, separation of the gas from the gas-containing aqueous solution is maximized.

The gas-containing aqueous solution falls freely to induce aeration by vortex turbulence. When bubbling blast begins, automatic reactions take place to obtain a bubble drink in the form of a bubble colloid. In each step of the bubbling engineering, a functional material and a fermented food can be easily added. Further, addition of strains, culture of inocula and strains, and/or necessary fermentation techniques can be readily controlled and implemented. In view of the foregoing, a very simple bubbling fermentation technique was invented.

To produce a bubble drink in an easy and effective manner, the present inventor invented and combined the following techniques.

A reaction procedure is programmed on the processing characteristics (e.g., hydrophilic saccharine crystalloid, hydrophobic pores and electrostatic adsorption of powders) of reaction materials while being less affected by the natures of the reaction materials. Thus, the reaction bases can be readily set by manipulation of powder processing, colloidal surface reactions and gas ingredients contained in a gas-saturated drink, selection of aerobic or anaerobic fermentation, and control of the fermentation rate, so that the reaction procedure, sequence and rate can be adjusted and checked in each step.

The binding states of the powder materials are monitored by the addition of various extract powders (coffee, ginseng steamed red, honey, green tea, pollen, charcoal, tobacco (ash) extract powders) to program the viscosity values in each step, so that the surface energy of the grain powder is preserved and the viscosity of the colloidal aqueous solution is enhanced. In the course of this process, the roles of the saccharine crystalloid are to 1) induce diffusion, 2) increase the viscosity in each step, 3) control the reaction rate, and 4) function as a material to be fermented.

Since bubbling seeds are captured and the protein colloidal solution is used as a bubbling agent, the size of bubble cells can be precisely controlled by varying the amount of the solution (trapping of moisture by the saccharide+trapping of surface active reaction materials by the grains)

Free fall and vortex turbulence are employed as aeration triggers for colloidal explosive reactions.

Accordingly, the height of the free fall is controlled to adjust an increase in the entropy of the bubble colloid.

Since the functional fermented bubble drink of the present invention comprises a fermented food and a pharmacologically active functional ingredient, it controls biological functions, prevents various diseases, such as diabetes, controls diseases to assist in the recovery from the diseases, and controls biological rhythm. To this end, ginseng products, such as ginseng steamed red, polysaccharides of mushrooms, and extracts and powders thereof may be used. Further, physiologically active substances and glycosides of fermented organic acids and carbohydrates may be used.

Other nutritive substances applicable to the bubble drink of the present invention are as follows: Silkworm extract, propolis, antioxidants and polysaccharides contained in all fruits (e.g., apple), all kinds of yeasts, enzymes, fungi and microbes, gymnosperms, angiosperms, ferns, algae, fungi, moss, cnidaria, echinodermata, nematoda, mollusca, brachiopoda, nematomorpha, rotifera, arthropoda, bryozoa, porifera, acanthocephala, entoprocta, chaetognatha, sipunculida, tardigrada, nemathelminthes, nemertina, chordate, platyhelminthes, annelida, calcium, magnesium, iron, soybean paste, hot pepper paste, mixed soybean paste with red pepper paste, soup prepared with fermented soybeans, salted fish, xylooligosaccharides, SOD and GST enzymes, flavonoid glycosides of unripe tangerine, flavonoid glycosides of all animals and plants, pectin, fructose, fruit juices, essence, carotenoid, flavonoid, alkaloids, limonoid, lactic acid, glutamate oxaloacetate transaminase, glutamatepyrurate, kimchi, slices of radish or cucumber dried and seasoned with soy, pickled radish, mastoparan B, neuropeptides, phospholipid, caseinphosphopeptide, lysine, B subtilis, isoflavone, saponin, phytic acid, choline, dietary fibers, extract and powder of Acanthopanax senticosus, carotenoids, tocopherol, tocotrienol, glucosinolate, immune enhancing ingredients from vegetables and herbs, vectors, all food additive complements, salmon milt protein, proteins of all animals and plants, carbohydrates, fats, calcium, minerals, vitamins, five essential nutrients, all nutrients, angiotensin-converting enzyme (ACE) inhibitors, thrombolytic agents, anti-skin-aging substances, (elastase), levan, glucosamine, protein hydrolysates, glucosamine salts, DHA calcium, nanosized calcium, soybean powder extract, soybean extract, noni and soybean extract, animal vegetable proteins, extracts of seaweeds (e.g., brown algae), hemp powder, pomegranate extracts, Saint John sweet extract, Rubus suavissium extract, water-soluble whey calcium powder, chitosan powder, oyster, young antlers of deer, ginseng, Chinese pepper, Picrorrhiza kurroa Bentham, red rice yeast, chlorella, Acanthopanax senticosus, aloe vera, garlic, onion, ginger, guar gum, seeds of all vegetables (e.g., grape), extracts and powders of cactuses, wild flowers and mushrooms, rutin, chondroitin sulfate, astaxanthin sweetener, food flavors, emulsifiers, preservatives, vitamins, antioxidants, stabilizers, xanthane, flavorings, colorants, bleaching agents, enhancers, quality improvers, defoaming agents, blowing agents, other additives, isoflavone, chlorophyll of plants, dietary fibers, functional coloring matters of Monascus sp. (red rice yeast extract), skin activating components, yeasts, fermented soybeans, all kinds of alcoholic drinks, kojic acid, red rice yeast enzymes of seaweeds (e.g., sea tangle), unsaturated fatty acids, saturated fatty acids, isoflavone, vitamin E, MS bacteria, starch, arrowroot, sugar, inorganic matter, polyphenol, flavonoid, hyphae of all mushrooms (e.g., basidiomycetes), eicosapentaenoic acd (EPA), polysaccharide peptide (PSP), interferons, retinol, luteolin, transresveratrol, IgY, peptides, bifidus bacteria, lactoferrin, whey, glycomacropeptides, sialic acid, immunoglobulin, lactoalbumin, galactose, galactosides, ganglioside, chondroitin sulfate, isoflavone, hesperidin, PDF, plant organic and inorganic germanium and ceramic (GE-132), tangerine peel extract (Jbb-1), nanomaterials of carbohydrates, acidic materials enhancing the activity of alcohol dehydrogenase present in Hovenia dulcis Thumb, rice extracts, carotin of brightly colored vegetables, cellulose alginate, cellulase, catalase, oxydo-reductase, phytase, protease, carbohydrase, lipase, yolk, the white of eggs, linolenic acid, recitin, cellular life complex, growth inhibitors of Helicobacter sp., anti-caries antibodies, soybean extract, caffeine, Monacolin K, nucleic acids, grass wood vinegar, chlorella, extracts of all beans (e.g., almond and peanut), cyclic adenosine monophosphate, lipids, glycerol, fatty acid esters, acetone, kephalin, cycline, cyclin-dependent kinases (CDKs), norepinephrine, gramicidin, amanitin, peptides, acid alkaline protease, all drugs and quasi-drugs, insulin, oxytocin, glutathione, angiotensin, bradykinin, all organic acids, physiological saline, bronchodilators, surfactants, proteolytic materials, physiologically active substances of bryophytes, picrom, epinephrine, trypsin, auxin, giberellin, phenolic substances, pupation hormones, apsicine, cell membranes, cholesterol, pectin, solitonics, hyphae of mushrooms, inorganic phosphoric acid, lipoic acid, lactic acid bacteria, sulfoxides, pyruvic acid, α-ketoglutaric acid, thiamine, coenzymes (CoA), operons, all hormones, glutamic acid, alanine dehydrogenase, glycogen, phosphorylase, growth hormones of ecdysone, steroid and thyroxine, glucose, amino acids, all mineral vitamins, indole acetic acid, colostrum, NAD (coenzyme), thiamine pyrophosphate, ATP, inorganic phosphoric acids, citric acid, itaconic acid, glutamic acid, lysine, ethanol, butanol, alcohol, lactic acid, kojic acid, penicillin, cortisone, butyric acid, racemate, insect pheromones, hydroxytyramine, catecholamine, dopamine, tantalic acid, lectin, glycoconjugates, agricultural antibiotics, cytokinin, hirudine, saponin, dietary fibers, chitosan, functional microbes, squalene, xylitol, hydrocolloid, all plant extracts (physiologically active substances), anticancer-active substances of Saururus chinensis Baill, Houttuynia cordata Thumb, rice, chestnut tree, cinnamon, buckwheat, soybean, potato, green perilla and sesame, flavonoid, lactophenin, Lysium chinense, antifungal microbial agents, beneficial strains, amino acids, isoleucine, threonine, valine, trytophane, alanine, aspartic acid, proline, oxyproline, calcium, -glucan, CMC, complex lipids, EPA, DAA, dextrin, chaff extracts, chlorophyll, extracts of physiologically active substances from all healthy foods, drugs, quasi-drugs, minerals, soil, plants and animals, tourmaline extract, and extracts of nutritious substances having pharmacological effects.

The functional fermented bubble drink of the present invention is a kind of instant food produced by converting fermented materials to be ingested into a blast of bubbled structure in 3 state complexity of solid, liquid and gas. Also, the functional fermented bubble drink of the present invention is a kind of storable food produced by converting a fermented food into a drink having an improved structure. Of course, the functional fermented bubble drink of the present invention may be combined with another drink, for example, a conditioner capable of optimizing the absorption of nutrients from a food (e.g., vegetable soup), to constitute a menu for ingestion.

According to the functional fermented bubble drink of the present invention, the kinds and the mounts of a raw material, a catalytic material, a strain for fermentation and a fermented concentrate used in the final foam-generating step are selected and their contents are optionally selected and controlled. Therefore, the characteristics of the bubble drink can be adjusted to provide the bubble drink as a custom-made or custom-ordered product according to the demand of consumers. In addition, the bubble drink of the present invention can be used to provide high-quality drinks having various characteristics according to the demand of consumers belonging to a particular social class. Furthermore, the bubble drink of the present invention can be provided by determining an ingestion program depending on the kinds of food and nutrients and controlling the ingestion of the food and nutrients by the program.

Having described the present invention it will be apparent to one of ordinary skill in the art that many changes and modifications may be made to the above-described embodiments without departing from the spirit and the scope of the present invention.

What is claimed is:

1) A method for producing a functional fermented bubble drink using a bubbling engineering process, the method comprising the steps of:
a) steaming and drying or slightly parching natural grains, pulverizing the dried or parched natural grains to prepare a fine powder of roasted grains, adding functional ingredients and fermented food ingredients to the fine powder of roasted grains while maintaining the humidity of the fine powder below 5%, and pulverizing the mixture to prepare a powder having a size of 10 μm or less in a first step;
b) pulverizing a crystalline powder or granular crystal of a monosaccharide or oligosaccharide to prepare a crystalloid powder having a size of 10 μm or less, and controlling the composition and characteristics of the saccharide necessary for glycosylation as a second step;
c) preparing a powder or an extract of functional raw materials selected from strains, inocula, and/or powders, extracts, powdery pills and concentrates of ginseng steamed red, etc, to impart particular additional functions such as fermentation to a final bubble drink product as a third step;
d) mixing the raw materials prepared in the first, second and third steps, controlling the particle size of the mixture, adding a functional material to the powder, and mixing the mixture with a colloidal solution in the form of a protein emulsion-suspension to prepare a food concentrate in a gel state in a forth step;
e) pulverizing, rotating or swirling the food concentrate while adding a liquid to the food concentrate to convert the gel into a sol, and freely dropping a gas-saturated solution on the sol to generate a bubble blast and
f) storing the bubble drink consisting of separates of liquid and foam phases in one container, or separating the two phases and storing in different containers as a fifth step;

2) The method of claim 1, wherein, in the third step, the functional raw materials may be in the form of a powder of pulverizing the lyophilized food or an extract prepared by lyophilizing a fermented food.

3) The method of claim 1, wherein, in the fourth step, functional materials are further added during mixing of the raw materials prepared in the previous steps, taking into consideration the purpose of drinking, functions, and demand and taste of a consumer.

4) The method of claim 1, wherein CO₂ is added in the form of dry ice powder during the mixing.

5) The method of claim 1, wherein the bubble drink consisting of separates of liquid and foam phases prepared in the fifth step is tightly sealed, followed by alcoholic fermentation or lactic acid bacteria fermentation.

6) The method of claim 1, wherein, in the fifth step, vegetable soup is further added during conversion of the gel into a sol.

7) The method of claim 6, wherein the vegetable soup is prepared by gently heating one-half of a carrot, one-fourth of a radish, one-fourth of dried radish leaves, one-fourth of a burdock and one dried oak mushroom in two liters of water for one hour, followed by cooling.

8) A bubble drink, which is produced by a method comprising the steps of:
a) steaming and drying or slightly parching natural grains, and pulverizing the dried or parched natural grains to prepare a fine powder of roasted grains, and adjusting the amount of the fine powder of roasted grains to the caloric intake of a consumer while maintaining the humidity of the fine powder below 5% (first step);
b) pulverizing a crystalline powder or granular crystal of a monosaccharide or oligosaccharide selected from solid substances including sugar, lactose, starch sugar, oligosaccharide, dextrin, α-starch and D-mannitol to prepare a saccharine crystalloid powder having a size of 10 μm or less (second step);
c) lyophilizing a fermented food and pulverizing the lyophilized food to prepare a powder of the lyophilized food or pulverizing a functional raw material for imparting particular functions to a final bubble drink to prepare a powder of the functional raw material (third step);
d) adsorbing and distributing the powders prepared in the previous steps in a wind tunnel to obtain a powder having a particle size of 10 μm or less, adding functional materials to the powder, and mixing the mixture with a colloidal solution, such as milk, in the form of a protein emulsion to prepare a food concentrate in a gel state (fourth step); and
e) pulverizing, rotating or swirling the food concentrate to convert the gel into a sol, and freely dropping a gas-saturated solution on the sol to generate a bubble blast (bubbling engineering process) (fifth step).

9) The bubble drink according to claim 8, wherein, in the fifth step, vegetable soup is further added to control the nutritive condition of the bubble drink.
